(19) United States
(12) Patent Application Publication
(10) Pub. No.: US 2007/0153419 A1
(43) Pub. Date: Jul. 5, 2007

(54) Perpendicular magnetic record medium and magnetic storage system

(75) Inventors: Reiko Arai, Kanagawa (JP); Katsumi Mabuchi, Ibaraki (JP); Mitsuhiro Shoda, Kanagawa (JP); Hiroyuki Matsumoto, Kanagawa (JP); Hiroyuki Nakagawa, Kanagawa (JP)

Correspondence Address: TOWNSEND AND TOWNSEND AND CREW LLP, TWO EMBARCADERO CENTER, 8TH FLOOR, SAN FRANCISCO, CA, 94111, US

(73) Assignee: Hitachi Global Storage Technologies Netherlands B.V., Amsterdam (NL)

(21) Appl. No.: 11/645,252

(22) Filed: Dec. 21, 2006

(30) Foreign Application Priority Data
Jan. 4, 2006 (JP) 2006-000181

(51) Int. Cl. G11B 5/74; G11B 5/02

(52) U.S. Cl. 360/131; 360/55

(57) ABSTRACT

Embodiments in accordance with the invention realize a perpendicular magnetic record medium with a high media S/N and excellent corrosion resistance. In a perpendicular magnetic record medium in accordance with an embodiment of the present invention prepared by forming an adhesion layer, an underlayer, a seed layer, an intermediate layer, and a recording layer sequentially on a substrate, the seed layer is specified to have a laminated structure consisting of a first seed layer and a second seed layer. The first seed layer consists of an amorphous alloy containing Cr and the second seed layer consists of an amorphous alloy predominantly composed of Ni with an fcc structure.

### CROSS-REFERENCES TO RELATED APPLICATIONS

The instant nonprovisional patent application claims priority to Japanese Patent Application No. 2006-000181, filed Jan. 4, 2006 and incorporated by reference herein for all purposes.

### BACKGROUND OF THE INVENTION

Embodiments in accordance with the present invention relate to a magnetic record medium capable of recording a large capacity of information, and more specifically to a magnetic record medium suitable for high-density magnetic recording, and a magnetic storage system using the magnetic recording medium.

Recently, a demand for making magnetic storage having a large capacity is strong, as in the case where a large-capacity magnetic disk apparatus is installed on not only personal computers but also household electric appliances, and therefore magnetic storages are required to have increased recording density. To cope with this, the magnetic head, the magnetic record medium, etc. are strenuously being developed. However, it is becoming difficult to improve the recording density using the longitudinal magnetic recording that has now been put into practical use. Then, the perpendicular magnetic recording is being investigated as a method to replace the longitudinal magnetic recording method.

In the case of the perpendicular magnetic recording, magnetization vectors adjacent to each other do not oppose with each other, and accordingly a high-density recording state is stable; therefore, it is a method essentially suitable to high-density recording. Moreover, in this recording method, by combining a write head of a single magnetic pole type and a double-layer perpendicular magnetic record medium having a soft underlayer, the recording efficiency can be increased and the method is compatible with increased coercivity of the recording film. However, in order to realize high-density recording by means of the perpendicular magnetic recording, it is necessary to develop a perpendicular magnetic record medium that is low-noise and highly resistive against thermal demagnetization.

As a recording layer of the perpendicular magnetic record medium, the CoCrPt-based alloy film that has been put in practical use for the longitudinal magnetic record medium is being studied heretofore. In order to attain a low noise characteristic using the CoCrPt-based alloy film, it is necessary to reduce magnetic exchange coupling between magnetic crystal grains using Cr segregation onto grain boundary, so that a magnetization reversal unit is made small. However, in the case where the amount of Cr is insufficient, in a formation process of the recording layer, the grains tend to coalesce mutually to expand or reduction in magnetic exchange coupling between crystal grains becomes insufficient, and accordingly the low noise characteristic cannot be attained. On the other hand, in the case where the amount of Cr is increased, a large amount of Cr remains in the grain, which lowers the magnetic anisotropy energy of the magnetic grain, and accordingly sufficient resistance against thermal demagnetization cannot be obtained.

In order to conquer such problems to attain the low noise characteristic, the recording layer of a granular type composed of a CoCrPt alloy with an oxide added therein, for example, as shown in Japanese Patent Laid-open Application JP 2003-178413 A, has begun to be studied actively. In the case where this recording layer of a granular type is used, since the magnetic exchange coupling between the magnetic grains is reduced by forming a grain layer of an oxide so that it surrounds the magnetic grains, a material with a high magnetic anisotropy energy can be used as the CoCrPt alloy, regardless of Cr concentration. Moreover, since the grain layer of the oxide is crystallographically discontinuous with the magnetic grains and has a thickness to some amount, coalescence of the grains in the formation process of the recording layer does not take place easily. Therefore, the perpendicular magnetic record medium of a granular type composed of a CoCrPt alloy with an oxide added therein attracts attention as a candidate of the perpendicular magnetic record medium that is low noise and resistive against thermal demagnetization.

A seed layer and an intermediate layer of the perpendicular magnetic record medium have been studied broadly until now. For example, a finding that Ru is suitable for the intermediate layer of the perpendicular magnetic record medium of an oxide granular type is reported in IEEE Transactions on Magnetics, Vol. 38, No. 5, p. 1976 (2002). Moreover, a finding that crystalline orientation of the Ru intermediate layer can be improved by a Ta seed layer is reported in IEEE Transactions on Magnetics, Vol. 38, No. 5, p. 1979 (2002).

Hitherto, regarding the seed layer in connection with the perpendicular magnetic record medium, attention is focused only on improvement of crystalline orientation of Ru that is the intermediate layer, and corrosion resistance has not been fully studied so far. Then, a corrosion resistance test was conducted about the perpendicular magnetic record medium of an oxide granular type using both a Ta seed layer with which a high media S/N was attainable and a Ru intermediate layer, and many corrosion points were observed which indicated the existence of a problem in corrosion resistance. On the other hand, in the case where a non-magnetic CoCr alloy that was well known as the intermediate layer of the conventional longitudinal magnetic record medium was used for the intermediate layer, it was found that although the corrosion resistance was improved, the media S/N lowered considerably. A problem is that with a combination of the intermediate layer material and the seed layer material hitherto known, the high media S/N and the corrosion resistance cannot be made compatible with each other.

### BRIEF SUMMARY OF THE INVENTION

Embodiments in accordance with the present invention realize a perpendicular magnetic record medium with a high media S/N and excellent corrosion resistance. In a perpendicular magnetic record medium in accordance with an embodiment of the present invention prepared by forming an adhesion layer, an underlayer, a seed layer, an intermediate layer, and a recording layer sequentially on a substrate, the seed layer is specified to have a laminated structure consisting of a first seed layer and a second seed layer. The first seed layer consists of an amorphous alloy containing Cr and the second seed layer consists of an amorphous alloy predominantly composed of Ni with an fcc structure.

### BRIEF DESCRIPTION OF THE DRAWINGS

FIG. 1 is a diagram showing a composition example of a perpendicular magnetic record medium in accordance with an embodiment of the present invention.

FIG. 2 is a diagram showing relationships of a media S/N of the perpendicular magnetic record medium in accordance with an embodiment of the present invention, and of the number of corrosion points to the film thickness of the first seed layer.

FIG. 3 is a sectional schematic diagram showing a magnetic storage in accordance with one embodiment of the present invention.

FIG. 4 is a schematic diagram showing a relationship between a magnetic head and a magnetic record medium in accordance with an embodiment of the present invention.

### DETAILED DESCRIPTION OF THE INVENTION

One object of an embodiment in accordance with the present invention is to realize a medium with a high media S/N and excellent corrosion resistance by selecting materials of the intermediate layer and the seed layer and a combination of materials regarding a perpendicular magnetic record medium.

Another object of an embodiment of the present invention is to provide a magnetic storage that makes full use of performance of this perpendicular magnetic record medium.

In order to attain the above-mentioned objects, in the perpendicular magnetic record medium such that at least a soft layer, a seed layer, an intermediate layer, a magnetic recording layer, and an over coat are sequentially laminated on a substrate, the seed layer is specified to have a double-layer structure; its lower layer consists of an amorphous alloy containing Cr, and its upper layer consists of a crystalline alloy predominantly composed with Ni with a face centered cubic lattice (fcc) structure.

A layer in which corrosion becomes a prime problem in the perpendicular magnetic medium is the layer of a Co alloy that is used for the soft underlayer. The Co alloy is not excellent in corrosion resistance and, in addition, gives rise to galvanic corrosion (corrosion between different kinds of metals) between itself and adjacent Ru or a Ru alloy because it has an extremely less noble potential in an aqueous solution environment. Since Ru or the Ru alloy has an extremely high potential because of being a noble metal, a potential difference between the Co alloy and the Ru alloy (or Ru) reaches as high as about 1.0 V; therefore, corrosion of the Co alloy is considerably accelerated by galvanic corrosion as compared with corrosion of a single body. In the case where a granular type oxide is used for the magnetic recording layer, Ru or the Ru alloy that is the intermediate layer underlying that layer must be made to have excellent crystalline orientation and large surface unevenness in order to accelerate segregation of the oxide to the grain boundary of the recording layer. Since there are many defects in such a structure in terms of corrosion, the layer does not exhibit a protective effect to suppress corrosion of the soft layer although Ru or the Ru alloy has excellent corrosion resistance. Because of this point, a role of the seed layer becomes important in order to suppress the corrosion of the soft underlayer.

Characteristics of the seed layer demanded from the viewpoint of corrosion may include as follows:
(1) A metal or an alloy used for the seed layer is easy to be passivated in an aqueous solution, and its oxide is stable and highly corrosion-resistant in the aqueous solution.
(2) The potential of the metal or the alloy is placed in a mid point between the intermediate layer and the soft layer and, if possible, has a potential gradient.
(3) The formed film is smooth and dense.
(4) Debond energies of the intermediate layer and the soft layer that are located as upper and lower layers of the seed layer, respectively, to the seed layer are high, and the both layers have excellent adhesiveness thereto. A corrosion environment is basically an aqueous solution. However, there is the possibility that acidification or alkalinization due to decomposition of a lubricant agent, mixing of a chloride, etc. may occur, and accordingly the seed layer is required to be corrosion-resistant in an environment of a wide pH range.

It has been discovered that as a composition of the seed layer satisfying such requirements, a seed layer of a double layer structure such that the upper layer is an alloy layer predominantly composed of Ni and the lower layer is an amorphous layer containing Cr makes it possible to realize high corrosion resistance, and at the same time this structure enables crystalline orientation of Ru that is the intermediate layer to be optimized.

Regarding the above-mentioned item (1), susceptibility to passivation of each layer and stability of the oxide can be estimated roughly by a Pourbaix diagram. In the case of Ni, since its oxide is stable in neutral to alkali ranges, it is considered that the corrosion resistance becomes high in these ranges. In an acid range, since Ni does not form an oxide or hydroxide stable in the acid range, it corrodes if an oxidizer coexists. One of approaches of further improving the corrosion resistance of the Ni layer is alloying. As metals that form solid solutions for all ratios of Ni, there are Co, Cu, and Fe. As metals that have solid solubility of 30% or more, there are Cr, Mo, Wo Pt, Ta, V, etc. Among these metals, Cr is considered able to extremely improve the corrosion resistance by its addition. It is conceivable that the reason is sufficient passivation that is developed by addition of Cr to an oxidizing acid. In addition to Cr, since Ta also passivates Ni in a wide pH range, it is expected that Ta improves the corrosion resistance just like Cr. W and Mo form oxides stable in the acid range to the neutral range, although the passivation range is narrow. V forms an oxide stable in the alkali range just like Ni, although the potential range is wider than that of Ni, which is expected from the Pourbaix diagram. Therefore, it is considered that alloying by addition of these metals has a recognizable effect in improving the corrosion resistance, although the degree of improvement is low as compared with the addition of Cr.

On the other hand, it is expected that Cr is good to improve the corrosion resistance since Cr forms an oxide or hydroxide stable in a wide pH range from the weak acid range to the alkali range. Cr can further extend a passive range through alloying. As addition elements for alloying, there can be enumerated Ti, Zr, Ta, Mo, W, Ni, Ru, etc. Since Ti, Ta, etc. among these metals show a passive range in a wide pH range, it is considered that addition of any of these metals further improves the corrosion resistance. The inventors found that especially Ta, as an addition element, was extremely excellent to improve the corrosion resistance when the ratio of Ta was increased to 50% or more. Moreover, Ti of the addition element has a property of not causing pitting corrosion (localized corrosion) in a chloride aqueous solution in the vicinity of ordinary temperature. This is because the Ti ion does not form a choler complex, but hydrolyzes immediately to be TiO₂.

It has been discovered that potentials of metals in an aqueous solution in which the perpendicular magnetic record medium was expected to be exposed were ranked in the order: Ru, Ru alloy >Ni, Ni alloy, and Cr, Cr alloy >Co, Co alloy from the higher one. Moreover, it was found that in an aqueous solution in which a chloride was mixed, the potential of Ni was higher than the potential of Cr. Therefore, it is indicated that Ni, Ni alloy, Cr, and Cr alloy satisfy the above-mentioned requirement (2).

Moreover, in an acid environment, the potential of the Ni alloy becomes almost equal to the potential of the soft underlayer, becoming lower than the potential of the Cr alloy. In this case, since the Ni alloy acts as a sacrificial anode of the alloy containing Cr that protects the soft underlayer, it is possible to improve the corrosion resistance of the Cr alloy, and thus it becomes possible to prevent corrosion of the soft underlayer. From the above characteristics, it is considered that by laminating a Ni-based alloy and a Cr-based alloy, a layer having the corrosion resistance in a wide pH range can be composed, and that by arranging the Ni-based alloy as the upper layer and arranging the Cr-based alloy as the lower layer, galvanic corrosion between the intermediate layer and the soft underlayer can be suppressed.

Regarding the above-mentioned item (3), Cr crystallizes and the unevenness of its surface becomes large. Since the seed layer is only several nanometers thick, deterioration in corrosion resistance caused by a decrease in coverage is conceivable. In contrast to it, it was found that a Cr-Ti alloy in which Ti was added by 50% became of an amorphous structure, excelling in smoothness. In the Ni-based alloy, when V, Cr, Ta, etc. are added, it excels in smoothness, and the surface of the substrate is uniformly covered with it.

Regarding the above-mentioned item (4), the peel strengths of an interface between the intermediate layer and the seed layer and of an interface between the seed layer and the soft underlayer were calculated using molecular dynamics simulation. Cr is characterized by having low peel strengths to Ru of the intermediate layer and also to a Co alloy of the soft underlayer, not having high adhesiveness. However, if Ti, Mo, W, Co, etc. are added to Cr, the peel strength, especially with the soft layer, increases and the adhesiveness is increased. Moreover, it was found that the peel strength, especially with Ru, increased with addition of Ta, Cr, Mo, W, etc. to Ni. In terms of adhesiveness, the seed layer is divided into two layers; a Ni-based alloy and a Cr-based alloy are arranged in the upper layer and in the lower layer, respectively, as in the case of suppression of galvanic corrosion. By this configuration, the medium can be formed into the perpendicular magnetic record medium with high adhesiveness.

Even a metal alone, such as Ta and Zr, forms an oxide stable in a wide pH range in the Pourbaix diagram. Since these metals, however, cannot satisfy the above items (3) and
(4), it is considered that they cannot be used as the seed layer.

According to an embodiment of the present invention, by selecting a seed layer consisting of an amorphous alloy containing Cr and a crystalline alloy predominantly composed of Ni with an fcc structure this is formed on the amorphous alloy, a double-layer perpendicular magnetic record medium with a high media S/N and excellent corrosion resistance can be realized.

Further, embodiments in accordance with the present invention can achieve a magnetic storage having a recording density of 25 Gbit/cm² or more by constructing a magnetic storage that has the perpendicular magnetic record medium of the above-mentioned invention, means for driving the magnetic record medium in a recording direction, a magnetic head consisting of a recording unit and a reproduction unit, means for moving the magnetic head relative to the magnetic record medium, and signal processing means for waveform-processing an input signal and an output signal to/from the magnetic head.

One embodiment of a perpendicular magnetic record medium in accordance with an embodiment of the present invention was manufactured using an ANELVA sputtering system (C3010). This sputtering system is constructed with ten process chambers and one substrate introduction chamber, and each chamber is evacuated independently. Exhaust capacity of all the chambers is 6×10⁻⁶ Pa or better.

The perpendicular magnetic record medium of embodiments of the present invention may be such that an adhesion layer is formed on the substrate, a soft underlayer is formed on the adhesion layer, a seed layer is formed on the soft underlayer, an intermediate layer is formed on the seed layer, and a perpendicular recording layer is formed on the intermediate layer.

For materials of the adhesion layer, the material is not limited specifically as long as it excels in adhesiveness with the substrate and surface flatness. However, it may be desirable that the adhesion layer include an alloy containing at least two kinds of metals selected from among Ni, Al, Ti, Ta, Cr, Zr, Co, Hf, Si, and B. More specifically, NiTa, AlTi, AlTa, CrTi, CoTi, NiTaZr, NiCrZr, CrTiAl, CrTiTa, CoTiNi, CoTiAl, etc. can be used.

For materials of the soft underlayer, the material is not limited specifically as long as the following conditions are satisfied: its saturation magnetic flux density (Bs) is at least 1 T or more, the disk substrate is given uniaxial anisotropy in its radial direction, the coercivity measured in a magnetic head run direction is 1.6 kA/m or less, and it is excellent in surface flatness. Specifically, when an amorphous alloy predominantly composed of Co or Fe with Ta, Hf, Nb, Zr, Si, B, C, etc. added therein is used, the above-mentioned characteristic is easy to be attained. The use of the film of a thickness of 20 nm or more enables the coercivity to be controlled small, and the use of the film of a thickness of 150 nm or less enables control of the spike noise to be controlled and enables floating magnetic field resistance to be improved.

In order to further reduce a noise of the soft underlayer, a non-magnetic layer is inserted into the soft underlayer, and the upper and lower soft layers are combined in an antiferromagnetic manner through this non-magnetic layer. It is preferable if magnetic moments of the upper-side soft layer above the non-magnetic layer and the lower-side soft layer below the magnetic layer are made equal, closed magnetic flux is established between the two layers, and states of magnetic domains of the two layers are more stabilized. It is desirable to use Ru, Cr, or Cu as a material of the non-magnetic layer.

In order to surely give uniaxial anisotropy to the soft underlayer, it may be desirable to conduct a cooling process in a magnetic field. Preferably, the magnetic field is applied in a radial direction of the substrate. To saturate magnetization of the soft layer in a radial direction, the magonoitude of the magnetic field may be at least 4 kA/m or more on the disk substrate. As to the cooling temperature, although it is desirable to cool the soft layer to room temperature, lowering the temperature to about 60-100° C. is ideally realistic when shortening of a time of a medium manufacture process is considered. Moreover, a time as to when the cooling process should be conducted is not necessarily after the formation of the soft layer depending on a medium formation process. The process may be done after the formation of the intermediate layer or the recording layer.

The seed layer has the double-layer structure comprising the first seed layer and the second seed layer as named from the substrate side to the outer side. The first seed layer formed on the substrate side is formed mainly for the purpose of suppressing corrosion of the soft underlayer, and an amorphous alloy containing Cr can be used therefor. Here, “amorphous” means a state of a material that does not show a distinct diffraction peak other than a halo pattern in an X-ray diffraction spectrum or a state that a mean grain size obtained from a lattice image taken with a high-resolution electron microscope is not more than 5 nm.

Specifically, it is desirable that the first seed layer consist of an alloy containing one or more kinds of elements selected from among Ta, Ti, Nb, Al, and Si in combination with Cr. More specifically, it is desirable to use CrTi, CrTa, CrNb, CrTiNb, CrTiSi, CrTiAI, TaCrNb, or TaCrSi. The second seed layer formed on the recording layer side aims at controlling orientation of the intermediate layer and controlling a grain size of the intermediate layer. For this, a crystalline alloy predominantly composed of Ni with an fcc structure can be used. Specifically, the second seed layer consists of an alloy containing one ore more kinds of elements selected from among Ta, Ti, Nb, Wo, Cr, V, Mo, and Cu in combination with Ni.

More specifically, it is desirable to use NiW, NiCr, NiTa, NiTi, NiV, NiMo, NiCu, NiCrTa, NiCrNb, NiCrW, NiTiNb, NiCuNb, or the like.

For the intermediate layer, there can be used a simple metal of Ru, an alloy predominantly composed of Ru with a hexagonal closed packed (hcp) structure or an fcc structure, or an alloy with a granular structure. Moreover, the intermediate layer may be a single layer film, or a multilayer film that uses materials whose crystal structures are mutually different may be used.

For the perpendicular recording layer, an alloy containing at least Co and Pt can be used. Moreover, an alloy with a granular structure predominantly composed of CoCrPt with an oxide added therein, specifically CoCrPt-SiO₂, CoCrPt-MgO, CoCrPt-TaO, etc. can be used. Furthermore, artificial lattice films, such as a (Co/Pd) multilayer, a (CoB/Pd) multilayer, a (Co/Pt) multilayer, a (CoB/Pt) multilayer, can be used.

It may be desirable to form a film predominantly composed of carbon with a thickness of 2 nm or more and 8 nm or less as an over coat of the perpendicular recording layer and further desirable to use a lubricant layer, such as a perfluoro alkyl polyether. By these selections, a high-reliability perpendicular magnetic record medium can be obtained.

For the substrate, a glass substrate, an Al alloy substrate with a NiP plating film coated thereon, a ceramic substrate, and a substrate on whose surface concentric circular grooves are formed by texture processing can be used.

Recording and reproducing characteristics of the medium were evaluated using a spin-stand. A head used for evaluation is a compound magnetic head that consists of a read sensor using the giant magnetoresistance with a shield gap length of 55 nm and a track width of 120 nm and a single magnetic pole writing element with a track width of 170 nm. A reproduction output and a noise were measured under conditions of a circumferential speed of 10 n/s, a skew angle of 0°, and a magnetic spacing of about 15 nm. The media S/N was calculated as a ratio of a solitary-wave reproduction output when recording a signal with a track recording density of 1970 fr/mm to an integrated noise when recording a signal of a track recording density of 23620 fr/mm.

The following procedure was taken to evaluate corrosion resistance. First, a sample is exposed for 96 hours under conditions of a high temperature and high humidity state of a temperature of 60° C. or more and a relative humidity of 90% RH or more. Next, the number of corrosion points existing within a range of radii from 14 mm to 25 mm is counted using an optical surface analyzer, and the samples are placed in the following ranks. A sample of a count less than 50 is evaluated as rank A, a sample of a count from 50 inclusive to 200 not inclusive as rank B, a sample of a count from 200 inclusive to 500 not inclusive as rank C, and a sample of a count of 500 or more as rank D. From a practical point of view, the rank B or higher is desirable.

Hereafter, concrete embodiments to which the present invention is applied will be described with reference to the drawings.

### FIRST EMBODIMENT

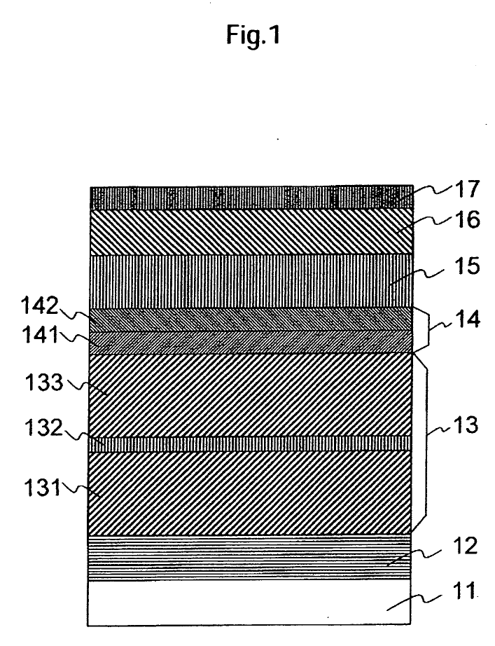

FIG. 1 shows a layer configuration of a perpendicular magnetic record medium of this embodiment. A glass disk substrate 0.63 mm thick and 6.5 mm in diameter (2.5-inch type) on whose surface concentric circular grooves are formed is used as a substrate 11. An adhesion layer 12, a soft underlayer 13, a first seed layer 141, a second seed layer 142, an intermediate layer 15, a perpendicular recording layer 16, and an over coat 17 were formed sequentially on the substrate 11 by a sputtering method. Table 1 summarizes target compositions, Ar gas pressures, and film thicknesses that were used in this embodiment.

TABLE 1

| | | Target | Ar gas | | |
|---|---|---|---|---|---|
| | | composition | pressures | Rate | Thickness |
| | | (at. %) | (Pa) | (nm/s) | (nm) |
| Adhesion layer 12 | | Ni₆₃Ta₃₇ | 1 | 5 | 10 |
| Soft | First soft | Co₉₂Ta₃Zr₅ | 0.5 | 12.5 | 50 |
| underlayer | layer 131 | | | | |
| 13 | Non- | Ru | 1 | 0.7 | 0.8 |
| | magnetic | | | | |
| | layer 132 | | | | |
| | Second | Co₉₂Ta₃Zr₅ | 0.5 | 12.5 | 50 |
| | soft layer | | | | |
| | 133 | | | | |
| Seed layer | First seed | Cr₅₀Ti₅₀ | 0.5 | 1 | 2 |
| 14 | layer 141 | | | | |
| | Second | Ni₉₄W₆ | 1 | 2 | 5 |
| | seed layer | | | | |
| | 142 | | | | |

| | | | | |
|---|---|---|---|---|
| Intermediate layer 15 | Ru | 2 | 0.3 | 16 |
| Recording layer 16 | CoCrPt-SiO₂ | 2 | 1 | 16 |
| Over coat 17 | Carbon | 0.6 | 1 | 5 |

First, the following layers with respective thicknesses were formed sequentially on the substrate 11: NiTa of 10 nm thickness which was the adhesion layer 12; CoTaZr (at %) of 10 nm thickness that was a first soft layer 131, Ru of 0.8 nm thickness which was a non-magnetic layer 132; and CoTaZr (at %) of 0.8 nm thickness which was a second soft layer 133. Then, the substrate 11 was cooled to about 80° C. in a magnetic field. Next, the following layers were formed thereon: 50Cr-50Ti of 2 nm thickness which was the first seed layer 141; 94Ni-6W (at %) of 5 nm thickness which was the second seed layer 142; Ru of 16 nm thickness which was the intermediate layer 15; CoCrPt-SiO₂ of 16 nm thickness which was the recording layer 16; and the carbon of 5 nm thickness which was the over coat 17. Then, a lubricant agent of a perfluoro alkyl polyether system material diluted with a fluorocarbon material was applied, and the surface thereof was processed with vanishing to fabricate a perpendicular magnetic record medium 1-1 that was this embodiment. Ar was used as sputtering gas and oxygen was added thereto with a partial pressure of 20 mPa when forming the magnetic recording layer. When forming the over coat 17, nitrogen was added with the partial pressure of 50 mPa to Ar pressure of 0.6 Pa at the time of film formation.

Examination of a media S/N and corrosion resistance of the medium 1-1 of this embodiment revealed that a high media S/N of 18 dB or more and excellent corrosion resistance of rank A were obtained.

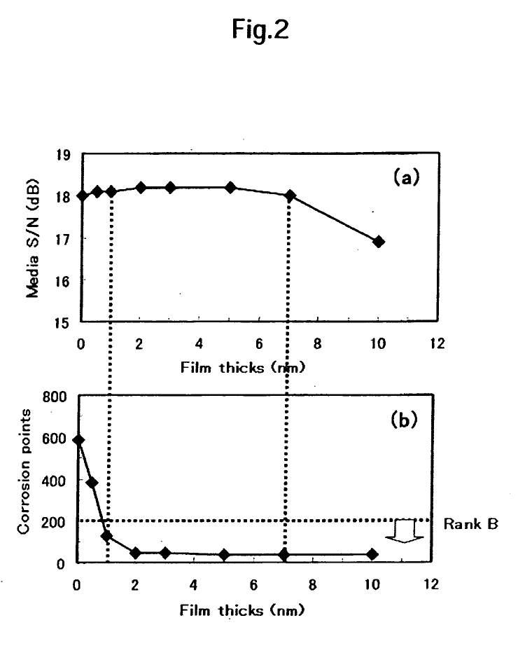

Next, relationships of the corrosion resistance and of the media S/N were examined, respectively, with varying film thickness of the first seed layer of CrTi. FIG. 2A shows the relationship between the media S/N and the film thickness of CrTi that is the first seed layer, and FIG. 2B shows the relationship between the number of corrosion points and the film thickness of CrTi. Here, the film thickness of NiW that is the second seed layer was fixed to 5 nm. The high media S/N was obtained for each film thickness up to 7 nm and a characteristic value of nearly 18 dB was attained regardless of the increase in the film thickness. However, if the film thickness becomes 8 nm or more, the media S/N becomes deteriorated. A cause of this is considered a decrease in recording efficiency by increase in the film thickness of the seed layer. On the other hand, if the film thickness of CrTi is 1 nm or more, excellent corrosion resistance of rank B is obtained. It was found that the corrosion count decreased and the corrosion resistance increased with increasing film thickness.

Further, several media with the second seed layer of NW each of which had a different film thickness were manufactured, and the media S/N and the corrosion resistance were evaluated. Table 2 shows the results. Here, the film thickness of CrTi that is the first seed layer was fixed to 2 nm. For each of the media 2-1 to 2-4, a high media S/N of about 18 dB was obtained, but the media S/N of the medium 2-5 was deteriorated. This is considered because when the film thickness of NiW that is the second seed layer becomes thick, surface unevenness becomes large and accordingly the characteristic of the recording layer is deteriorated, which leads to a lower media S/N. About the corrosion resistance, each medium was placed in rank A.

TABLE 2

| | Film thickness of second | | | Rank of corrosion |
|---|---|---|---|---|
| Sample | seed layer of NiW | | Media S/N (dB) | resistance |
| 2-1 | 3 | nm | 18.0 | A |
| 2-2 | 5 | nm | 18.1 | A |
| 2-3 | 7 | nm | 18.1 | A |
| 2-4 | 10 | nm | 17.9 | A |
| 2-5 | 20 | nm | 16.2 | A |

Next, a relationships of the media S/N and the corrosion resistance was investigated for different compositions of the first seed layer and of the second seed layer. Table 3 shows the results. Here, the film thickness of the first seed layer of CrTi and the film thickness of the second seed layer of NiW were set to 2 nm and 5 nm, respectively. First, attention is paid on Cr content of CrTi. For each of the media 3-1 to 3-3, a high media S/N of 18 dB or more and excellent corrosion resistance of rank A were obtained regardless of the Cr content. The medium 3-4 with a Cr content of 70 at % has an increased corrosion count and deteriorates in corrosion resistance. An X-ray diffraction measurement was performed about each composition, and the crystal structure of CrTi was checked. The result indicated that CrTi with a Cr content of 20-55 at % was of an amorphous structure and 70Cr-30Ti was of a crystal structure into which a bcc was intermingled.

The investigation of a crystal structure of NiW formed on the CrTi indicated that each NiW layer had an fcc crystal structure but 70Cr-30Ti whose media S/N was deteriorated had poor (111) orientation of the NiW as compared with other compositions. That is, a ratio in the composition of CrTi for obtaining a medium with a high media S/N and excellent corrosion resistance is determined to be in such a range that allows CrTi to have an amorphous structure and renders fcc (111) orientation of NiW formed thereon excellent.

Next, attention is paid on W content of NiW that is the second seed layer. Each of the media 3-5 to 3-7 achieved a high media S/N of about 18 dB and excellent corrosion resistance regardless of the W content. As shown in the medium 3-8, a W content of 20% causes a decrease in the media S/N. The investigation of a crystal structure by X-ray diffraction, just as described above, showed that NiW with a W content of 15 at % or less was of an fcc crystal structure, whereas 80Ni-20W was of a crystal structure into which a bcc was intermingled. That is, it was found that when the NiW alloy had an fcc crystal structure, a high media S/N could be obtained. From these findings, it was found that in order to make a high media S/N and excellent corrosion resistance compatible with each other, it is desirable that an amorphous alloy is formed as the first seed layer on the substrate side and a crystalline alloy with an fcc structure is formed thereon as the second seed layer.

TABLE 3

| | | | Rank of | |
|---|---|---|---|---|
| | First seed layer | Second seed | corrosion | Media S/N |
| Sample | 141 | layer 142 | resistance | (dB) |
| 3-1 | Cr₂₀Ti₈₀ | Ni₉₂W₈ | A | 18.0 |
| 3-2 | Cr₄₀Ti₆₀ | Ni₉₂W₈ | A | 18.1 |
| 3-3 | Cr₅₅Ti₄₅ | Ni₉₂W₈ | A | 18.1 |
| 3-4 | Cr₇₀Ti₃₀ | Ni₉₂W₈ | B | 17.6 |
| 3-5 | Cr₅₀Ti₅₀ | Ni₉₅W₅ | A | 18.0 |
| 3-6 | Cr₅₀Ti₅₀ | Ni₉₀W₁₀ | A | 18.0 |
| 3-7 | Cr₅₀Ti₅₀ | Ni₈₅W₁₅ | A | 17.9 |
| 3-8 | Cr₅₀Ti₅₀ | Ni₈₀W₂₀ | A | 16.4 |

In this embodiment, the medium is optimum with the following conditions: the film thickness of CrTi that is the first seed layer is from 1 nm to 7 nm inclusive and the Cr content is less than 70 at %; and the film thickness of NiW that is the second seed layer is less than 20 nm and the W content is less than 20 at %. However, the optimum film thickness and composition shown above may become different depending on materials and thicknesses of materials of the recording layer and the intermediate layer and their combinations with a head used for evaluation.

### SECOND EMBODIMENT

According to the second embodiment, a medium with the same layer configuration as that of the medium 1-1 of the first embodiment but with a different seed layer was fabricated, and its media S/N and corrosion resistance were evaluated with the same technique as used in the first embodiment. A composition, a film thickness, and a film formation process of each layer except the seed layer are the same as those of the medium 1-1. Here, each material used for the first seed layer was an amorphous alloy, and each material used for the second seed layer was a crystalline alloy with an fcc structure. Film thicknesses were set to 2 nm and 5 nm, respectively.

TABLE 4

| | | | Rank of | |
|---|---|---|---|---|
| | First seed layer | Second seed | corrosion | Media S/N |
| Sample | 141 | layer 142 | resistance | (dB) |
| 4-1 | Cr₅₀Ti₅₀ | Ni₉₀Cr₁₀ | A | 18.1 |
| 4-2 | Cr₅₀Ti₅₀ | Ni₉₀V₁₀ | A | 18.2 |
| 4-3 | Cr₅₀Ti₅₀ | Ni₉₀Mo₁₀ | A | 18.0 |
| 4-4 | Cr₅₀Ti₅₀ | Ni₉₀Ta₁₀ | A | 18.0 |
| 4-5 | Cr₅₀Ti₅₀ | Ni₉₀Cu₁₀ | A | 18.0 |
| 4-6 | Cr₅₀Ti₅₀ | Ni₉₀Ti₁₀ | A | 18.1 |
| 4-7 | Cr₅₀Ti₅₀ | Ni₉₀Cu₅Nb₅ | A | 18.2 |
| 4-8 | Cr₅₀Ti₅₀ | Ni₉₀Cr₅Nb₅ | A | 18.0 |
| 4-9 | Ta₇₀Cr₃₀ | Ni₉₂W₈ | A | 18.2 |
| 4-10 | Cr₇₀Nb₃₀ | Ni₉₂W₈ | A | 18.0 |
| 4-11 | Cr₅₀Ti₄₅Nb₅ | Ni₉₂W₈ | A | 18.3 |
| 4-12 | Cr₅₀Ti₄₅Al₅ | Ni₉₂W₈ | A | 18.2 |
| 4-13 | Cr₅₀Ti₄₅Si₅ | Ni₉₂W₈ | A | 18.2 |
| 4-14 | Ta₆₅Cr₃₀Al₅ | Ni₉₂W₈ | A | 18.0 |
| 4-15 | Ta₆₅Cr₃₀Si₅ | Ni₉₂W₈ | A | 18.1 |

The media 4-1 to 4-8 are ones such that their first seed layers are fixed to CrTi, and materials of their second seed layers are changed. Moreover, the media 4-9 to 4-15 are ones such that their second seed layers are fixed to NiW, and materials of their first seed layers are changed. As shown in Table 4, it was found that each medium showed a high media S/N of 18 dB or more and excellent corrosion resistance of rank A. Moreover, with a combination other than the combination shown in this embodiment, the same effect can be attained as long as conditions that the first seed layer is an amorphous alloy containing Cs and the second seed layer is a crystalline alloy predominantly composed of Ni with an fcc structure are satisfied. With a composition other than the composition shown in this embodiment, the same effect can be attained, if the above conditions are satisfied.

### THIRD EMBODIMENT

According to a third embodiment, several media with the same layer configuration as that of the medium 1-1 of the first embodiment but with a recording layer different from that medium were manufactured, and their media S/N's and corrosion resistance were evaluated using the same technique as used in the first embodiment. A composition, a film thickness, and a film formation process of each layer except the recording layer are the same as those of the medium 1-1. The medium 5-1 consists of the recording layer with a granular structure composed of CoCrPt with a Ta oxide added therein. The recording layers of the medium 5-2 and the medium 5-3 consist of a multilayer of Co and Pd and a multilayer of Co and Pt, respectively.

As shown in Table 5, each corrosion resistance was excellent, being placed in rank A. The medium 5-1 was the best in terms of the media S/N. Thus, it was found that even if the Co/Pd or Co/Pt multilayer was used for the recording layer, the excellent media S/N was obtained with the seed layer of this invention and that the best effect was given for the recording layer with a granular structure composed of the CoCrPt-based alloy with an oxide added therein.

TABLE 5

| | Recording layer | | |
|---|---|---|---|
| | configuration, | | |
| | Number in | | |
| | parentheses: | Rank of corrosion | |
| Sample | thickness(nm) | resistance | Media S/N (dB) |
| 5-1 | CoCrPt—TaO(14) | A | 18.4 |
| 5-2 | [Co/Pd]₂₀(14) | A | 17.2 |
| 5-3 | [Co/Pd]₂₀(14) | A | 17.5 |

### FOURTH EMBODIMENT

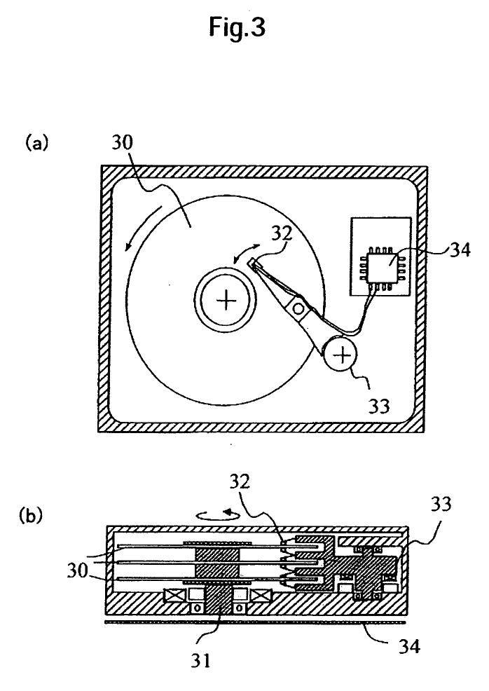

FIG. 3 shows a sectional schematic diagram of a magnetic storage medium according to an embodiment of the present invention. A magnetic record medium 30 has the same layer configuration as that of the medium 1-1 of this experimental example. The magnetic storage was constructed with a drive 31 for driving this magnetic record medium 30, a magnetic head 32 consisting of a recording unit and a reproduction unit, means 33 for moving the magnetic head relative to the magnetic record medium, and means 34 for outputting and inputting a signal to/from the magnetic head. A magnetic flying height of the magnetic head 32 was determined 15 nm. The reproduction unit uses the magnetoresistance effect and a main pole of the recording unit uses a single magnetic pole type head. With this device configuration, an operation of 27.9 Gbit/cm² was successfully checked by setting the track recording density per centimeter to 354600 bits and setting the track density per square centimeter to 78740 tracks.

### FIFTH EMBODIMENT

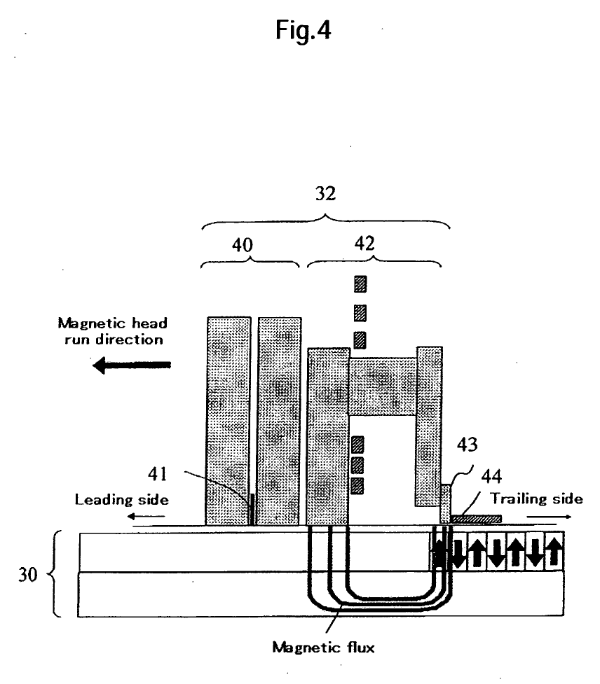

FIG. 3 shows a sectional schematic diagram of a magnetic storage according to an embodiment of the present invention. A magnetic record medium 30 has the same layer configuration as that of the medium 1-1 of this experimental example. The magnetic storage was constructed with the drive 31 for driving this magnetic record medium 30, the magnetic head 32 consisting of a recording unit and a reproduction unit, the means 33 for moving the magnetic head relative to the magnetic record medium, and the means 34 for outputting and inputting a signal to/from the magnetic head. FIG. 4 shows a relationship between the magnetic head 32 and the magnetic record medium 30. A magnetic flying height of the magnetic head was determined 15 nm. A giant magnetoresistive (GMR) element was used for a read sensor 41 of a reproduction unit 40, and the magnetic head has a wraparound shield 44 formed around a main pole 43 of a recording unit 42. Thus, the gradient of a recording magnetic field is made steep by using the magnetic head such that the shield is formed around the main pole of the recording unit. At the same time, an overwrite characteristic can be improved while the high media S/N is maintained by using a magnetic record medium on which a third recording layer is formed. Namely, an operation at 32.4 Gbit/cm² was successfully checked by setting the track recording density per centimeter to 374100 bits and setting the track density per square centimeter to 86620 tracks.

Moreover, the same effect can be attained using a tunneling magnetoresistive (TMR) element (CPP) other than the read sensor 41 of the giant magnetoresistance effect as shown in FIG. 4.

### COMPARATIVE EXAMPLE

As a comparative example, the medium 6-1 whose seed layer 14 was only the first seed layer 141 composed of CrTi of 2 nm thickness and the medium 6-2 whose seed layer 14 was only the second seed layer 142 composed of NiW of 5 nm thickness were prepared. In addition, the medium 6-3 in which NiW of 5 nm thickness was formed on the soft underlayer 13 and CrTi of 2 nm thickness was formed thereon, the medium 64 in which Cr having a bcc structure of 2 nm thickness was formed on the soft underlayer 13 and NiW of 5 nm thickness was formed thereon, and the medium 6-5 in which NiTa, an amorphous alloy, of 5 nm thickness was formed on CrTi (2 nm) were prepared. Further additionally, the medium 6-6 in which NiTa, an amorphous alloy not containing Cr, of 2 nm thickness was formed as the first seed layer, the medium 6-7 in which Pt of 5 nm thickness having an fcc crystal structure was formed as the second seed layer, and the medium 6-8 in which PtNi of 5 nm thickness was formed were prepared. In the medium 6-6, NiW of 5 nm thickness was formed as the second seed layer; in the medium 6-7 and the medium 6-8, CrTi of 2 nm thickness was formed as the first seed layer, respectively. Other part of the layer configuration is the same as the counterpart of the medium 1-1 of the embodiment.

Table 6 shows results of a corrosion resistance rank, the media S/N, and the half width of the rocking curve of Ru(0002) diffraction for the medium 1-1 of the embodiment and the media 6-1 to 6-8 of the comparative example, all together.

TABLE 6

| | | | Rank of | | |
|---|---|---|---|---|---|
| | First seed | Second seed | corrosion | Media S/N | |
| Sample | layer 141 | layer 142 | resistance | (dB) | Δθ₅₀(deg) |
| 1-1 | Cr₅₀Ti₅₀ | Ni₉₄W₆ | A | 18.2 | 3.4 |
| 6-1 | Cr₅₀Ti₅₀ | x | B | 15.3 | 4.3 |
| 6-2 | x | Ni₉₄W₆ | D | 18.0 | 3.8 |
| 6-3 | Ni₉₄W₆ | Cr₅₀Ti₅₀ | C | 15.1 | 4.5 |
| 6-4 | Cr | Ni₉₄W₆ | C | 14.0 | 6.2 |
| 6-5 | Cr₅₀Ti₅₀ | Ni_{62.5}Ta_{37.5} | A | 15.2 | 4.3 |
| 6-6 | Ni_{62.5}Ta_{37.5} | Ni₉₄W₆ | C | 18.1 | 3.4 |
| 6-7 | Cr₅₀Ti₅₁ | Pt | C | 18.0 | 3.7 |
| 6-8 | Cr₅₀Ti₅₂ | Pt₈₀Ni₂₀ | C | 18.1 | 3.6 |

First, attention is paid on results of the corrosion resistance. As shown in the medium 1-1 of the embodiment and the medium 6-5 of the comparative example, by using an amorphous material containing Cr for the first seed layer and using a material containing Ni for the second seed layer, the medium exhibits excellent corrosion resistance of rank A. However, in the case of forming only NiW, as shown in the medium 6-2, and in the case of inversing the layer configuration of the medium 1-1, as shown in the medium 6-3 (i.e., a case of forming the material containing Cr on the material containing Ni), results of rank C or worse were obtained. Although the medium 6-1 in which only CrTi is formed is placed in rank B, its corrosion resistance becomes slightly worse, as compared with the medium 1-1.

The medium 64 exhibited a difference in corrosion resistance despite using Cr for the first seed layer and using the alloy containing Ni for the second seed layer. Moreover, the medium 6-6 was placed in rank C or worse in corrosion resistance despite using the amorphous alloy for the first seed layer.

This can be explained as follows. The Ni-based alloy does not form an oxide or hydroxide with a protective effect in an acid solution. Moreover, since the Ni-based alloy assumes an fcc crystal structure, there are many defects in the thin film, and accordingly the corrosion resistance is poor. In contrast to this, the Cr-based alloy forms an oxide or hydroxide stable in the acid range and has fewer defects because of being an amorphous alloy. Therefore, it excels in corrosion resistance. When corrosion progresses from the medium surface and reaches the second seed layer surface, the corrosion continues to progress to the first seed layer side, as it is, since the Ni alloy of the second seed layer is not so good in corrosion resistance as shown in the medium 6-2. When the corrosion reaches the first seed layer, since the Cr alloy used for the first seed layer has the corrosion resistance to some extent as shown in the medium 6-1, the progress of the corrosion is reduced slightly. However, the Ni alloy exists in the surroundings of this corrosion point. Since the Ni alloy has a low potential as compared with the Cr alloy, in a portion in contact with the Cr alloy, the Ni alloy dissolves and leads to a state of cathode anti-corrosion that drastically decreases corrosion of the Cr alloy. For this reason, the progress of the corrosion almost stops at the Cr alloy, and does not reach the soft underlayer underlying it.

As shown in the medium 6-6, if the Cr alloy is not formed in the first seed layer, the progress of the corrosion cannot be suppressed. As shown in the medium 6-3, if the order of the Ni alloy and the Cr alloy are changed between them, a cathode anti-corrosion function of the Ni alloy is not exerted and accordingly the corrosion resistance cannot be improved. That is, although the Cr alloy has the corrosion resistance to some extent, it is not sufficient. Therefore, only when the Ni alloy is laminated on the Cr alloy layer, the medium can be given extremely excellent corrosion resistance. There are many defects in the medium 6-4 because Cr of the first seed layer has a crystal structure, therefore degrading the corrosion resistance.

The medium 6-7 and the medium 6-8 use Pt or a Pt alloy for the second seed layer. The Pt alloy itself is a metal having excellent corrosion resistance. However, as shown in the medium 6-7 and the medium 6-8, when it is used for the seed layer, the medium is poorly placed in rank C as the corrosion resistance rank. Since Pt is a noble metal having a very high potential and is of a crystal structure, there are many defects in the Pt layer. Just like Ru does not show a protection effect for corrosion suppression of the soft underlayer as described above, the Pt alloy is not expected to improve the corrosion resistance. As shown in the medium 6-8, it was found that in the case where Ni was added to Pt, if the content of Ni was small, Ni hardly exerted the effect.

Next, attention is paid on the media S/N. Although high media S/N's of 18 dB or more were obtained with the medium 1-1 and the media 6-2, 6-6, 6-7, and 6-8 of the embodiment, each of other media exhibited a low media S/N of 16 dB or less. For each medium, a half width Δθ₅₀ of the rocking curve of Ru(0002) diffraction was measured using an X-ray diffractometer. As a result, it turned out that any sample with a low media S/N had a large Δθ₅₀, indicating bad crystalline orientation of Ru. As shown in the medium 6-4, it was found that in the case where the first seed layer was formed with a material having a crystal structure, crystalline orientation became especially worse. The medium 6-5 consists of the first seed layer composed of CrTi and the second seed layer composed of NiTa. Although, this layer configuration is almost the same as that of the medium 4-4 of the second embodiment, a difference in the media S/N between the two cases was observed. Whereas the second seed layer of the medium 4-4 that has a Ta content of as small as 10 at % and has a crystal structure, the medium 6-5 has a large Ta content and an amorphous structure. Moreover, it was found that a half width Δθ₅₀ of the rocking curve of Ru(0002) diffraction of the medium 6-5 was slightly large as compared with that of the medium 1-1 and its crystalline orientation of Ru was bad. Thus, in the perpendicular magnetic record medium having the a granular type recording layer composed of a CoCrPt alloy with an oxide added therein, in order to attain a high media S/N (for example, 18 dB or more), it is more desirable to improve the crystalline orientation of Ru. It turns out that in order to realize this, a crystalline alloy predominantly composed of Ni is suitable for the second seed layer.

From the foregoing, in order to make a high media S/N and excellent corrosion resistance compatible with each other, it is desirable that an amorphous alloy containing Cr is formed as the first seed layer on the substrate side and a crystalline alloy predominantly composed of Ni with an fcc structure is formed thereon as the second seed layer.

What is claimed is:

1. A perpendicular magnetic record medium such that a soft layer, a seed layer, an intermediate layer, a recording layer, and an over coat are sequentially laminated on a substrate,
wherein the seed layer has a first seed layer on the soft layer side and a second seed layer on the intermediate layer side, the first seed layer consists of an amorphous alloy containing Cr, and the second seed layer consists of a crystalline alloy predominantly composed of Ni.

2. The perpendicular magnetic record medium according to claim 1,
wherein the first seed layer is an amorphous alloy containing one or more kinds of elements selected from among Ta, Ti, Nb, Si, and Al in combination with Cr.

3. The perpendicular magnetic record medium according to claim 1,
wherein the second seed layer consists of a crystalline alloy having a face centered cubic lattice (fcc) structure.

4. The perpendicular magnetic record medium according to claim 1,
wherein the second seed layer having a face centered cubic lattice structure containing one or more kinds of elements selected from among Cr, Ta, Ti, Nb, V, W, Mo, and Cu in combination with Ni.

5. The perpendicular magnetic record medium according to claim 1,
wherein the intermediate layer consists of Ru or a Ru alloy.

6. A magnetic recording apparatus comprising:
a magnetic record medium;
means for driving the magnetic record medium in a recording direction,
a magnetic head consisting of a recording unit and a reproduction unit,
means for moving the magnetic head relative to the magnetic record medium, and
signal processing means for waveform-processing an input signal and an output signal to/from the magnetic head,
wherein the magnetic record medium is such that a soft layer, a seed layer, an intermediate layer, and an over coat are sequentially laminated on a substrate, and the seed layer has a first seed layer on the soft layer side and a second seed layer on the intermediate layer side,
the first seed layer consisting of an amorphous alloy containing Cr, and the second seed layer consisting of a crystalline alloy predominantly composed of Ni.

7. The magnetic recording apparatus according to claim 6,
wherein the first seed layer is an amorphous alloy containing one or more kinds of elements selected from among Ta, Ti, Nb, Si, and Al in combination with Cr.

8. The magnetic recording apparatus according to claim 6,
wherein the second seed layer consists of a crystalline alloy having a face centered cubic lattice (fcc) structure.

9. The magnetic recording apparatus according to claim 6,
wherein the second seed layer has a face centered cubic lattice (fcc) structure containing one or more kinds of elements selected from among Cr, Ta, Ti, Nb, V, W, Mo, and Cu in combination with Ni.

10. The magnetic recording apparatus according to claim 6,
wherein the intermediate layer consists of Ru or a Ru alloy.

11. The magnetic recording apparatus according to claim 6,
wherein the magnetic head is such that a recording unit is of a single magnetic pole type and has a structure for enclosing the surrounding of the single magnetic pole section with a shield.
